(19) United States
(12) Patent Application Publication
(10) Pub. No.: US 2024/0211992 A1
(43) Pub. Date: Jun. 27, 2024

(54) Allowing Changes to an Experiment While Ensuring Consistent and Valid Results

(71) Applicant: Google LLC, Mountain View, CA (US)

(72) Inventors: Deepa Thiruppathiraju, Fremont, CA (US); Vidya Visweswaran Iyer, Cupertino, CA (US); Sagar Subodh Shah, Redmond, WA (US); Pallavi Naresh Dhruva, San Carlos, CA (US); Shuichi Koga, Mountain View, CA (US)

(21) Appl. No.: 17/911,042

(22) PCT Filed: Nov. 9, 2021
(86) PCT No.: PCT/US2021/058626

§ 371 Date: Sep. 12, 2022

(51) Int. Cl. G06Q 30/0242

(52) U.S. Cl. CPC G06Q 30/0243

(57) ABSTRACT

Methods, systems, and apparatus include computer program encoded on a computer-readable storage medium for conducting an experiment for a campaign. A subset of current campaign parameters from a third party can be received, by a computing system, to be a set of test variables, where the set of test variables correspond to a proposed modification of a current campaign that is applied to a treatment campaign. The current campaign can be monitored for changes to the current campaign parameters. Based on a determination that the current campaign parameter that has been modified by the third party is outside the set of test variables, the modification to the current campaign parameter can be reproduced and propagated to the treatment campaign. An action to take can be determined based on the modified current campaign parameter causing a change to at least one of the set of test variables.

### FIELD

The present disclosure relates generally to the provision of content in campaigns. More particularly, the present disclosure relates to modifications made to one or more experimental campaigns.

### BACKGROUND

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

A content provider may have one or several goals related to the presentation of their content. However, the content provider may not be able to accurately predict the performance of their content for a number of reasons. In order to address this, experiments can be run that vary one or more aspects associated with selection criteria that are used to select a given content item for presentation with the resources. Such experiments may or may not produce a reasonable expectation of meeting the one or several goals.

### SUMMARY

Aspects and advantages of embodiments of the present disclosure will be set forth in part in the following description, or can be learned from the description, or can be learned through practice of the embodiments.

One example aspect of the present disclosure is directed to methods, systems, and apparatus for conducting an experiment for a campaign. A subset of current campaign parameters from a third party can be received, by a computing system, to be a set of test variables, where the set of test variables correspond to a proposed modification of a current campaign that is applied to a draft campaign. The current campaign can be monitored for changes to the current campaign parameters. Based on a determination that the current campaign parameter that has been modified by the third party is outside the set of test variables, the modification to the current campaign parameter can be reproduced and propagated to a treatment campaign (e.g., a subsequent, modified version of the draft campaign). An action to take can be determined based on the modified current campaign parameter causing a change to at least one of the set of test variables.

Another example aspect of the present disclosure is directed to periodically polling the current campaign run by the third party, comparing the current campaign parameter to a historical version of the current campaign parameter: and determining that the current campaign parameter has been modified by the third party from the historical version of the current campaign parameter.

Another example aspect of the present disclosure is directed to inferring that the modification by the third party to the current campaign parameter, while not part of the subset of current campaign parameters, should be tested by the treatment campaign, dynamically creating a new test variable can be dynamically created, and the set of test variables can be dynamically modified to include the new test variable.

Another example aspect of the present disclosure is directed to receiving the current campaign parameter that has been modified as input to an application programming interface, interpreting a functionality that has been modified as a result of the modification to the current campaign parameter, and then dynamically generating the functionality in a separate command structure to be implemented in the treatment campaign.

Another example aspect of the present disclosure is directed to determining that the modification to the current campaign parameter causes a change to at least one of the set of test variables, and based on the determination, dynamically creating a second treatment campaign to test the set of test variables separately from the treatment campaign.

Another example aspect of the present disclosure is directed to publishing the modification to the current campaign parameter to the treatment campaign based on the current campaign parameter not causing a modification to at least one of the set of test variables.

Another example aspect of the present disclosure is directed to storing the modification to the current campaign parameter as an experiment variable within the set of test variables.

Other aspects of the present disclosure are directed to various systems, apparatuses, computer-readable media which may be non-transitory, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 illustrates a block diagram of an example environment for conducting an experiment for a campaign according to example embodiments of the present disclosure.

FIG. 2 illustrates an example flow chart diagram of an example method for conducting an experiment for a campaign according to example embodiments of the present disclosure.

FIG. 3 illustrates an example campaign management system according to example embodiments of the present disclosure.

FIG. 4 illustrates a block diagram of an example system for conducting an experiment for a campaign according to example embodiments of the present disclosure.

FIG. 5 illustrates a block diagram of computing devices that may be used to implement the systems and methods described in this document, as either a client or as a server or plurality of servers.

Reference numerals that are repeated across plural figures are intended to identify the same features in various implementations.

### DETAILED DESCRIPTION

### Overview

Generally, the present disclosure is directed to the provision of content in campaigns, especially modifications to one or more experimental campaigns.

A campaign sponsor, an administrator of a campaign, or an automated process can provide an indication of a proposed modification to be made to one or more campaign parameters of a content campaign. The content provider may have one or several goals related to their campaigns that they track over time.

In order to measure the impact of a change to campaign data, an experiment can be run based on an experimental campaign to ascertain the effects of that change. In some embodiments, the content provider can be a third party to the system running the experiment. The experiment can, in some embodiments, maintain a control campaign (e.g., the original campaign) and then divert a percentage of traffic to the experimental campaign (e.g., a modified version of the original campaign testing the effects of the change to the campaign data). The safest way to run the experimental campaign would be to disallow any changes to the control campaign and/or experimental campaign for the duration of the experiment.

However, disallowing changes to the control campaign and the experimental campaign is too limiting to content providers who need to make updates to their campaigns that are unrelated to the experiment through the normal course of their business operations. Campaign data also needs to react to seasonal changes, the performance of the current campaign unrelated to the original experiment, updates to the business or underlying structure to their current campaign, etc. In many cases, when a content providers make changes, especially to parameters that weren't part of the experimental campaign, they don't expect that change to affect the accuracy of the experimental campaign—although sometimes it does. Therefore, it is not feasible in practice to lock down changes to the control campaign during the experiment.

The following provides a way to allow for changes to the control campaign during the course of the experiment while ensuring that results from the experimental campaign remain accurate. In embodiments, the experimental campaign can be a treatment campaign that tracks a subset of current campaign parameters from the content provider as a set of test variables. Since the content provider can be a third party from the party running the treatment campaign, methods and systems can dynamically monitor the content provider for any changes to any current campaign parameters, including current campaign parameters that are outside the original set of test variables. Those changes, once found, can be reproduced and propagated throughout the treatment campaign. If a change to one or more current campaign parameters affects a test variable, then it can be programmatically determined that the treatment campaign is no longer accurate. If the change does not affect the treatment campaign, then the change can be published to the treatment campaign and the experiment can continue (but updated).

The following example methods and systems describe example experimental campaigns that improve the internal workings of the device(s) on which it is implemented, such as translating and propagating campaign changes from one data format to another in order to facilitate the interaction of various parts of the system. For example, the methods and systems can reproduce and propagate modifications made by a third party in a first format to a campaign parameter of the treatment campaign in a second format. This can be done through an application programming interface (API) that can receive the third party modified campaign parameter as input, interpret a functionality that has been modified as a result of the modification to the campaign parameter, and then dynamically generate the functionality in a separate command structure to be implemented in the treatment campaign (e.g., as a different format compatible with the treatment campaign structure). This also reduces the amount of memory and latency within the system when monitoring many content provider campaigns as they change across time. Because these features are automated and dynamically generated, there is no requirement for the third party to inform the methods and systems herein of every change made to their campaigns and to specify the functionality that may or may not affect their preexisting experiment. Moreover, the systems and methods also improve the saving of data within data structures that facilitates faster searches and the generation of specific warning signals based on the predicted operation of the campaign changes. In addition, the system dynamically and automatically monitors for changes to a third-party campaign and uses that as input to various automated steps designed to ensure the treatment campaign remains accurate in its experimental results.

In some embodiments, a content campaign can include, for example, one or more groups of content items and selection criteria for each group. The proposed modification can be a modification to be made to one or more campaign parameters or the selection criteria associated with a group. In response to the provided indication of the proposed modification, a split to be applied can be determined, wherein the split can be between using campaign parameters or original selection criteria and the proposed modification against received traffic. In some implementations, the proposed modification can be stored as a treatment campaign. For example, the proposed modification can be stored in a first structure that includes only the differences that are proposed to the campaign and in a second structure that represents the campaign with the proposed modifications applied. An experiment can be conducted based on using received traffic and in accordance with the split including delivering impressions based on both the campaign parameters or original selection criteria and the proposed modification including serving content in accordance with the campaign and the treatment campaign.

In order to account for changes to the content campaign made by the content provider over time, in some embodiments, methods and systems can receive a subset of campaign parameters from the third party content provider to set up the initial experiment. The campaign parameters can be set as a group of one or more test variables, where the set of test variables can correspond to any type of proposed modification to the current campaign that is to be applied to the treatment campaign of the experiment. The current campaign can be dynamically monitored, either periodically or continuously, for any changes to current campaign parameters. If it is determined that a current campaign parameter has been modified by the content provider and is outside the set of test variables, the modification to the current campaign parameter can be reproduced and propagated in order to determine if the modified current campaign parameter causes a change to at least one of the set of test variables. If not, then the treatment campaign is modified to include the modification to the current campaign parameter, and the experiment continues to proceed. However, if one or more test variables are changed by this modification, then the treatment campaign will not include the modification to the current campaign parameter and/or the content provider can be notified that they made a change that affects the accuracy of the experiment.

For situations in which the systems discussed here collect information about users, or may make use of information about users, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be manipulated in one or more ways before it is stored or used, so that certain information about the user is removed. For example, a user's identity may be manipulated so that no identifying information can be determined for the user, or a user's geographic location may be generalized where location information is obtained (such as to a city, ZIP code, or state level), so that a particular location of a user cannot be determined. Thus, the user may have control over how information about the user is collected and used by a content server.

With reference now to the Figures, example embodiments of the present disclosure will be discussed in further detail.

### Example Devices and Systems

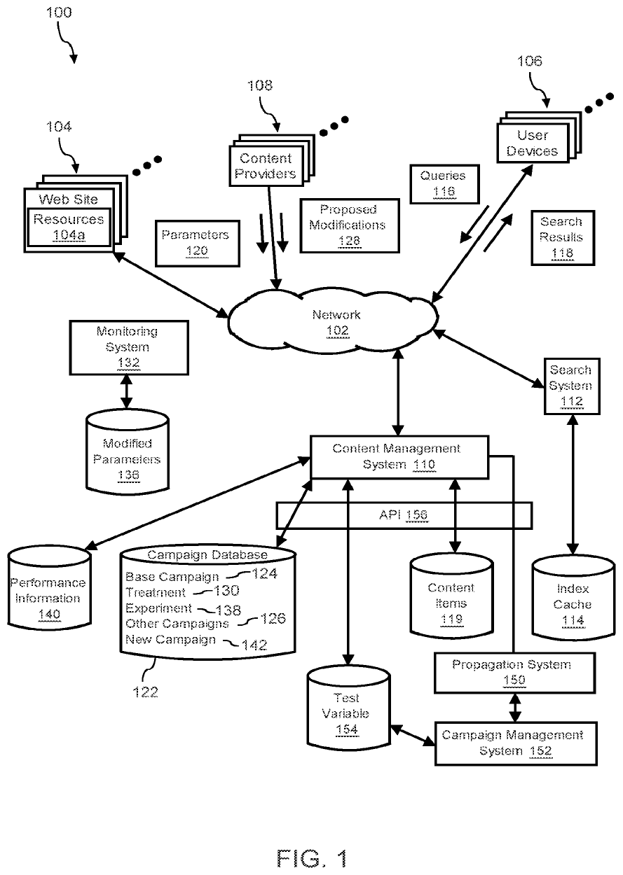

FIG. 1 illustrates a block diagram of an example environment for conducting an experiment for a campaign according to example embodiments of the present disclosure. The example environment 100 includes a network 102, such as a local area network (LAN), a wide area network (WAN), the Internet, or a combination thereof. The network 102 connects websites 104, user devices 106, content providers 108, publishers, and a content management system 110. The example environment 100 may include many thousands of websites 104, user devices 106, and content providers 108. The content management system 110 may be used for selecting and providing content in response to requests for content. The content providers 108 can be, for example, advertisers. Other types of content providers are possible.

A website 104 can include one or more resources 104a associated with a domain name and hosted by one or more servers. An example website 104 is a collection of web pages formatted in hypertext markup language (HTML) that can contain text, images, multimedia content, and programming elements, such as scripts. Each website 104 can be maintained by a content publisher, which is an entity that controls, manages and/or owns the website 104.

In some embodiments, a resource 104a can be any data that can be provided over the network 102. A resource 104a can be identified by a resource address that is associated with the resource 104a. Resources 104a can include, but are not limited to, HTML pages, word processing documents, portable document format (PDF) documents, images, video, and news feed sources. The resources 104a can include content, such as words, phrases, videos, images and sounds, that may include embedded information (such as meta-information hyperlinks) and/or embedded instructions (such as scripts).

A user device 106 can be an electronic device that is under control of a user and is capable of requesting and receiving resources 104a over the network 102. Example user devices 106 include personal computers, tablet computers, mobile communication devices (e.g., smartphones), televisions, set top boxes, personal digital assistants and other devices that can send and receive data over the network 102. A user device 106 can typically include one or more user applications, such as a web browser, to facilitate the sending and receiving of data over the network 102. The web browser can interact with various types of web applications, such as a game, a map application, or an e-mail application, to name a few examples.

A user device 106 can request resources 104a from a website 104. In turn, data representing the resource 104a can be provided to the user device 106 for presentation by the user device 106. User devices 106 can also submit search queries 116 to the search system 112 over the network 102. In response to a search query 116, the search system 112 can, for example, access the indexed cache 114 to identify resources 104a that are relevant to the search query 116. The search system 112 identifies the resources 104a in the form of search results 118 and returns the search results 118 to the user devices 106 in search results pages. A search result 118 can be data generated by the search system 112 that identifies a resource 104a that is responsive to a particular search query 116 and can include a link to the resource 104a. An example search result 118 can include a web page title, a snippet of text or a portion of an image extracted from the web page, and the URL (Unified Resource Location) of the web page.

The data representing the resource 104a or the search results 118 can also include data specifying a portion of the resource 104a or search results 118 or a portion of a user display (e.g., a presentation location of a pop-up window or in a slot of a web page) in which other content (e.g., advertisements) can be presented. These specified portions of the resource 104a or user display are referred to as slots or impressions. An example slot can be, for example, an advertisement slot.

When a resource 104a or search result 118 is requested by a user device 106, the content management system 110 may receive a request for content to be provided with the resource 104a or search result 118. The request for content can include characteristics of one or more slots or impressions that are defined for the requested resource 104a or search result 118. For example, a reference (e.g., URL) to the resource 104a or search result 118 for which the slot is defined, a size of the slot, and/or media types that are available for presentation in the slot can be provided to the content management system 110. Similarly, keywords associated with a requested resource 104a or a search query 116 for which search results 118 are requested can also be provided to the content management system 110 to facilitate identification of content that is relevant to the resource or search query 116.

Based, for example, on data included in the request for content, the content management system 110 can select (e.g., from a content items data store 119) content items that are eligible to be provided in response to the request, such as content items having characteristics matching the characteristics of a given slot (e.g., a slot within a webpage within which the content item can be inserted). The selection criteria can be based on characteristics such as slot duration, physical size, resolution, bandwidth allowance, and other display parameters of the slot. As another example, content items having selection criteria (e.g., keywords) that match the resource keywords or the search query 116 may be selected as eligible content items by the content management system 110. One or more selected content items can be provided to the user device 106 in association with providing an associated resource 104a or search results 118.

A content provider 108 or content provider can create a content campaign associated with one or more content items using tools provided by the content management system 110. For example, the content management system 110 can provide one or more account management user interfaces for creating and managing content campaigns. The account management user interfaces can be made available to the content provider 108, for example, either through an online interface provided by the content management system 110 or as an account management software application installed and executed locally at a content provider's client device.

In some embodiments, content management system 110 can receive from the content provider 108 a subset of campaign parameters 120 to be a set of test variables. The content provider 108 can be a third party from the content management system 110. The set of test variables can correspond to a proposed modification of a current campaign that is to be applied to a treatment campaign 130 managed by the content management system 110. For example, a content provider 108 can, using the account management user interfaces, provide campaign parameters 120 which define an experimental content campaign. The experimental content campaign can be created and activated for the content provider 108 according to the campaign parameters 120 specified by the content provider 108. Campaign parameters 120 can, for example, include, but is not limited to, a campaign name, a preferred content network for placing content, a budget for the campaign, start and end dates for the campaign, a schedule for content placements, content (e.g., creatives), bids, and selection criteria. Selection criteria can include, but is not limited to, a language, one or more geographical locations or websites, and/or one or more selection terms. The campaign parameters 120 can be stored in a campaign database 122, such as in association with a base campaign 124 or in association with one or more other campaigns 126.

The content provider 108 may propose one or more modifications 128 to the base campaign 124. As another example, one or more proposed modifications can be suggested by the content management system 110. The proposed modifications 128 can be, for example, modifications to one or more campaign parameters 120, such as selection criteria. The proposed modifications 128 can include, but are not limited to, the addition or removal of keywords, the changing of bids, and/or the changing of content (e.g., text) of a content item. Other modifications are possible, such as slot duration, physical size, resolution, bandwidth allowance, and other display parameters.

In some embodiments, a treatment campaign 130 can be stored in the campaign database 122. The modifications to the one or more campaign parameters 120 can be stored as test variables 154. In some embodiments, the treatment campaign 130 can be stored using a same schema as used for the base campaign 124 and the other campaigns 126.

An effect of applying the proposed modifications 128 to the base campaign 124 can be measured by running an experiment using live traffic. For example, an experiment 138 can be generated from the treatment campaign 130 and stored in the campaign database 122. The content management system 110 can determine a split as to using the experiment 138 or the base campaign 124 for received requests. For example, for a certain percentage (e.g., twenty percent) of received requests for content, the content management system 110 can include the experiment 138 in an auction associated with the request for content in place of the base campaign 130. The content management system 110 can determine performance information 140 for both the base campaign 124 and the experiment 138 during the experiment. The content provider 108 can view a comparison between performance information for the base campaign 124 and the experiment 138.

Based on viewing the comparison of performance information between the base campaign 124 and the experiment 138 and/or on viewing the simulation statistics 136, the content provider 108 may decide to implement the proposed modifications 128. For example, the proposed modifications 128 can be incorporated into the base campaign 130. As another example, the proposed modifications 128 can be included in a new campaign 142, with the new campaign 142 being a separate campaign from the base campaign 124.

The content provider 108 may, however, make changes to the live base campaign 124 subsequent to the creation of the treatment campaign 130. These changes may be made to the original test variables 154 and/or may be made to campaign parameters outside the original test variables 154. In addition, these changes may be made without any intention by the content provider 108 to cause a modification to the proposed modifications 128 being tested in the experiment.

In order to ensure that the experiment remains accurate and consistent with the original test parameters specified by the content provider's 108 proposed modifications 128, monitoring system 132 can monitor the current base campaign 124 for changes to campaign parameters. For example, in some embodiments the monitoring system 132 can periodically poll the current campaign run by the third party content provider 108 to check for any changes made by the content provider 108, including changes to campaign parameters outside the test parameters. The current campaign parameters can be compared to corresponding historical versions of those campaign parameters. If there is a difference between the current and historical campaign parameters, then monitoring system 132 can determine programmatically that the current campaign parameter has been modified by the content provider 108 from its historical version, and the modified parameter(s) can be stored in modified parameters store 136.

Content management system 110 can receive the modified parameter(s) from the modified parameters store 136 and reproduce and propagate the effect of each modified parameter to the treatment campaign 130. If the modified parameter is within the test variables 154, then the modified parameter is published to the treatment campaign 130 to continue the experiment with its diverted traffic.

However, if the modified parameter is outside of the test variables 154, propagation system 150 tests its effect on each test variable 154 by reproducing and propagating the modified parameter throughout the treatment campaign's 130 logic. If one or more test variables 154 are changed by the modified parameter, then the modified parameter is not published to the treatment campaign 130 and the content provider 108 is notified by the campaign management system 152 that the modified parameter affects the experiment. The notification to the content provider 108 can provide an alert that the experiment may have inaccurate results for their updated campaign, and the content provider 108 can decide whether to update the experiment, proceed with the knowledge that their current campaign is no longer an accurate control, or whether the content provider 108 will restore the modified parameter to its previous version. In some embodiments, campaign management system 152 can provide an estimation of the inaccuracies introduced by the modified parameter.

In some embodiments, an application programming interface (API) 156 can interpret the changes detected by monitoring system 132 and programmatically determine how to implement those changes within propagation system 150. For example, after receiving the campaign parameter that has been modified as input, the API 156 can dynamically interpret a functionality that has been modified as a result of the modification to the campaign parameter. The API 156 can then dynamically generate the functionality in a separate command structure to be implemented in the treatment campaign 130. The functionality can be input into propagation system 150.

In some embodiments, upon determining that the modification to the campaign parameter causes a change to at least one of the test variables 154, the campaign management system 152 can dynamically create a second treatment campaign (e.g., new campaign 142) to test the test variables 154 with the modification separately from the treatment campaign 130.

Additionally and/or alternatively, in some embodiments, the modification to the campaign parameter can be stored as a new experiment variable within test variables 154. For example, campaign management system 152 can infer that the modification by the content provider 108 to the campaign parameter, while not part of the original set of proposed modifications 128, should be tested by the treatment campaign 130 (e.g., by observing an uptick in conversions in past similar campaigns). In this case, the campaign management system 152 can dynamically create a new test variable and modify the test variables 154 to include the new test variable. In some embodiments, multiple branches of experiments can be run within other campaigns 126 testing various new test variables.

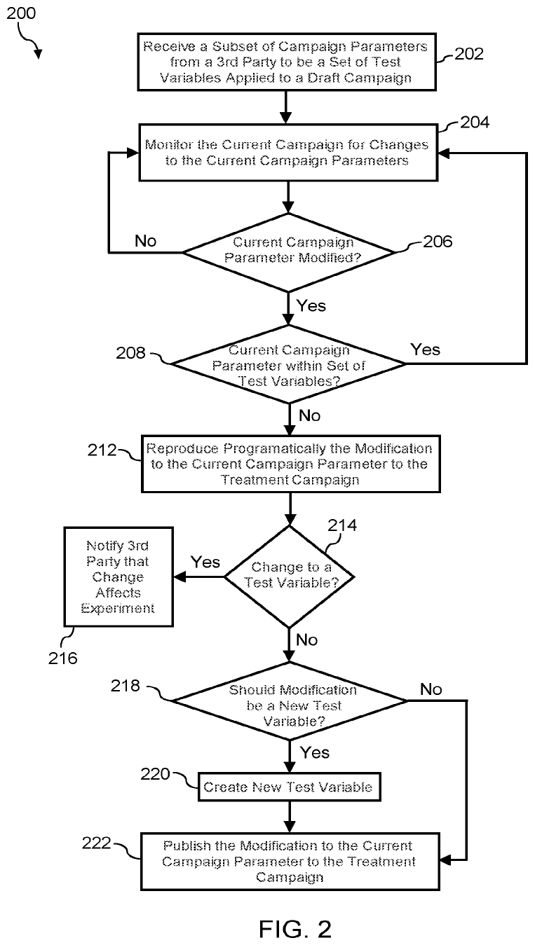

FIG. 2 illustrates an example flow chart diagram of an example method for conducting an experiment for a campaign according to example embodiments of the present disclosure. Although FIG. 2 depicts steps performed in a particular order for purposes of illustration and discussion, the methods of the present disclosure are not limited to the particularly illustrated order or arrangement. The various steps of the method 200 can be omitted, rearranged, combined, and/or adapted in various ways without deviating from the scope of the present disclosure.

Method 200 allows a content provider, often a third party, to make changes to a live base campaign subsequent to the creation of a treatment campaign in an experiment, while ensuring the results from the experiment consistently test the original test variables. For example, changes made by the content provider may be made to the original test variables and/or may be made to campaign parameters outside the original test variables. In addition, these changes may be made without an intention by the content provider to cause a modification to the proposed modifications being tested in the experiment.

In some embodiments, method 200 begins by receiving a subset of campaign parameters (such as current campaign parameters in the live base campaign) from a third party (e.g., content provider) to be a set of test variables. The set of test variables can correspond to a proposed modification of the base campaign that is to be applied to a treatment campaign in an experiment (step 202). A proportion of traffic can be directed to the treatment campaign as well as the base campaign, and campaign performance (conversions, click-through rates, engagement metrics, etc.) can be compared between the two campaigns.

In order to ensure that experimental results remain accurate after the content provider makes changes to the base campaign, the method 200 can monitor the base campaign for changes to any current campaign parameters (step 204). For example, the current base campaign run by the content provider can be periodically polled, such as by a monitoring system, that compares current campaign parameters to historical versions of those campaign parameters. This periodical polling can, in some embodiments, be dynamically determined. For example, the polling can increase in frequency during time periods when changes to the base campaign is expected (such as during busy seasons, around new product or service releases, etc.) or decrease in frequency during time periods when changes to the base campaign is less expected (such as for products that are on clearance, being discontinued, etc.).

Next, method 200 can determine whether one or more current campaign parameters have been modified by the content provider (step 206). For example, the monitoring system can store historical versions of the base campaign parameter(s), and then compare the current base campaign parameter to a historical version of that campaign parameter. If the current campaign parameter is the same or similar to the historical version of itself, then the monitoring system can continue to monitor the base campaign parameter(s). If the current campaign parameter is different from the historical version of itself, or is a new parameter entirely, then the monitoring system can send the parameter to the content management system.

In some embodiments, the content management system can determine whether the modified current campaign parameter is within the original and/or previous set of test variables, such as those stored in the test variables store (step 208). If the modified current campaign parameter is within the original and/or previous set of test variables, then there is no operation and the method continues to monitor for any third party changes. In some embodiments, alternatively, the test parameter can be modified within the treatment campaign. In this case, the original and/or previous set of test variables are able to be dynamically updated without explicit instruction from the content provider (e.g., an intention to update the test variable is inferred).

However, if the modified current campaign parameter is outside the original and/or previous set of test variables, then the content management system needs to determine whether the modified current campaign parameter will affect any of the original and/or previous set of test variables (and thereby unintentionally decreasing the accuracy of the experiment). In that case, the content management system can send the modified current campaign parameter to the propagation system, which can programmatically reproduce and propagate the modification to the current campaign parameter to the treatment campaign (step 212). However, it is not a one-to-one process to detect that a change has been made by the content provider and then implement that change programmatically to the treatment campaign. The change needs to be identified, interpreted, and then dynamically reconstructed within the system running the treatment campaign.

In some embodiments, an application programming interface (API) can receive, from the content management system and/or the monitoring system, the modified current campaign parameter as input. The API can interpret a functionality that has been modified as a result of the modification to the current campaign parameter, and then dynamically generate the functionality in a separate command structure to be implemented in the treatment campaign.

Method 200 can then determine whether the current campaign parameter modified by the content provider causes a change to at least one of the set of test variables (step 214). If, for example, the propagation system determines that the modification to the current campaign parameter causes a change to at least one of the set of test variables, then the campaign management system can notify the third party content provider that the modification affects the experiment (step 216). The modification can then be prevented from being applied to the treatment campaign.

If the modification to the current campaign parameter does not cause a change to a test variable, then the modification to the current campaign parameter can be published to the treatment campaign (step 222). In some embodiments, the campaign management system can dynamically create a new treatment campaign to test the set of test variables with the modified current campaign parameter separately from the treatment campaign. In that way, the original treatment campaign is preserved, but the new treatment campaign can test the updated version of the base campaign.

In some embodiments, the campaign management system can determine whether the modification to the current campaign parameter should be a new test variable (step 218). For example, the campaign management system can infer that the modification by the third party to the current campaign parameter, while not part of the subset of current campaign parameters, should be tested by the treatment campaign. The campaign management system can infer that a new test variable should be created by determining that the modification is predicted to cause a large change to the performance of the treatment campaign, causes a change to a similar parameter to a test variable, etc. If it's inferred that new test variable should be created, then the campaign management system can dynamically create a new test variable (step 220), and then dynamically modify the set of test variables to include the new test variable. For example, the modification to the current campaign parameter can be stored as an experiment variable within the set of test variables.

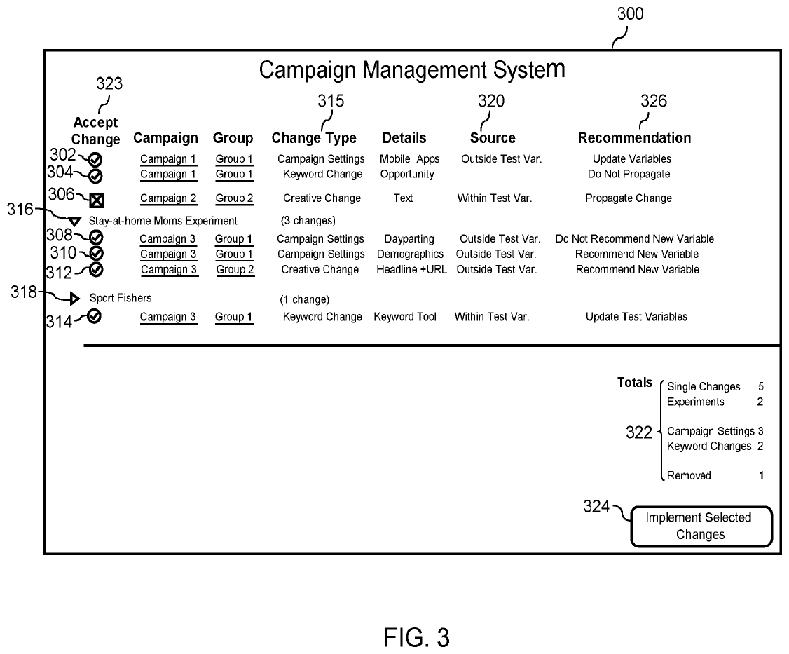

FIG. 3 illustrates an example campaign management system according to example embodiments of the present disclosure. An example user interface 300 is shown, which can allow a user to view and manage drafts and experiments. The user interface 300 includes rows 302-314 which each correspond to a detected modification to a campaign of the content provider. Rows 302, 308, and 310 each correspond to a detected respective campaign setting change (e.g., as indicated by respective entries in a column 315). For example, row 302 corresponds to the changing of selection criteria to include content requests from mobile applications. Row 308 corresponds to the changing of selection criteria to include the matching of a particular time of day. Row 310 corresponds to the changing of demographic selection criteria to include female users aged 25-45. Rows 304 and 314 each correspond to a change of a keyword. Rows 306 and 312 each correspond to the changing of content (e.g., text, heading, URL (Uniform Resource Locator) of a content item included in a campaign of the content provider.

The changes corresponding to rows 308, 310, and 312 are grouped under an experiment row 316. For example, the changes corresponding to rows 308, 310, and 312 can be included in an experiment related to stay-at-home mothers. The change corresponding to row 314 can be included in an experiment related to sport fishing that is associated with an experiment row 318.

The changes made by the content provider can correspond to rows 308, 310, 312, and 314 (e.g., the detected change being within or outside the original test variables as indicated by respective entries in a source column 320). For example, the changes can be detected by the monitoring system performing periodic or continuous polling of the website. The Recommendations corresponding to column 326 have been provided to the content provider as suggestions from, for example, the campaign management system which manages the content campaigns of the content provider in view of the results from the propagation system. The change corresponding to rows 302, 304, 306, 308, 310, 312, and 314 in column 326 has been provided by an automated opportunity system which automatically identifies opportunities for the content provider and presents such opportunities as suggested changes.

A summary area 322 includes a summary of the recommendations included in the rows 302-314. The content provider can use controls included in a column 323 to specify whether respective recommendations from the campaign management system are to be kept (e.g., accepted) or removed (e.g., rejected) by the content provider. For example, the recommendation corresponding to row 306 has been removed and the recommendations corresponding to rows 302-304 and 308-314 have been accepted. A control 324 can be selected to implement the accepted (e.g., selected) changes. Subsequent to selection of the control 324, the content provider can be presented with other user interfaces from which the content provider can provide further details, e.g., for running an experiment and/or for specifying whether an accepted change is to be incorporated into a respective campaign or whether an accepted change is to be implemented as one or more parameters in a newly created campaign.

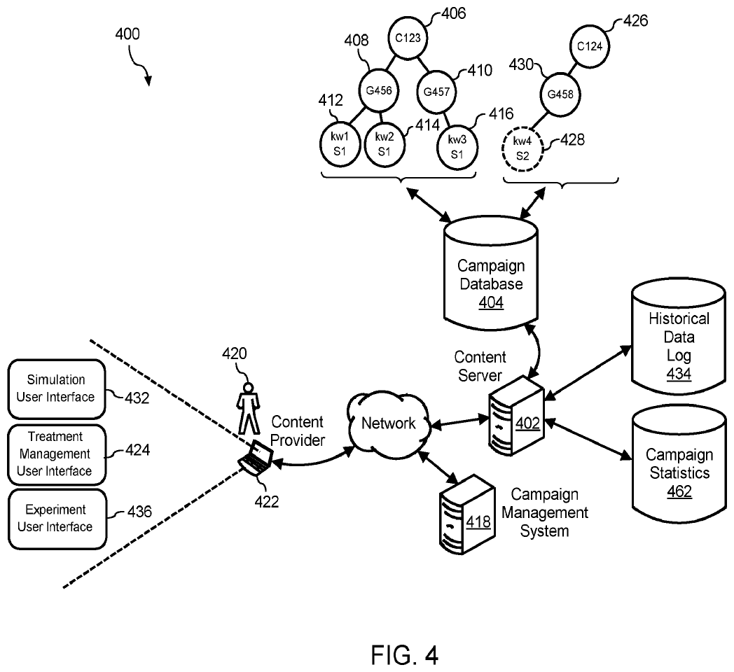

FIG. 4 illustrates a block diagram of an example system 400 for conducting an experiment for one or more treatment campaigns according to example embodiments of the present disclosure. A content server 402 can manage a campaign database 404. For example, the campaign database 404 can include a campaign data structure 406 for a treatment campaign “123”. The campaign data structure 406 can include information for a first test variable group “G456” 408 and a second test variable group “G457” 410. The first test variable group 408 and the second variable group 410 can each include a set of test variables for a treatment campaign being tested within content items (not shown).

In some embodiments, multiple testing arms can be created based on the creation of new test variables and/or the propagation of a change that would affect an original test variable (rather than not propagating the change). The first test arm 412 (e.g., “kw 1”), for example, would be based on a change to one or more test variables within the first test variable group “G456” 408, and the second test arm 414 (e.g., “kw2”) would be based on a different change to one or more test variables within the first test variable group “G456” 408. Test arms can also depend upon the second variable group 410, where a test arm 416 (e.g., “kw3”) would be based on a change to one or more test variables within the second test variable group “G457” 410.

For another campaign data structure 426 for treatment campaign “124”, the campaign data structure 426 can include information for a first test variable group “G458” 430 with a test arm 428 (e.g., “kw4”) that is based on a change to one or more test variables within the first test variable group 430. However, the change is outside the original test variables (e.g., the first test variable group “G458” 430) and causes a change to one of the variables, and so the content server 402 can prevent the change from being published to treatment campaign 426.

The changes to the test variables can be automatically received, for example, from a campaign management system 418 which automatically identifies potential modifications that may be beneficial to a content provider 420 associated with the campaign. These may take the form of new test variables added to an existing test variable group or triggers the creation of a new testing arm.

In some embodiments, the content server 402 can store a draft data structure 426 for the treatment campaign in the campaign database 404. The draft data structure 426 can be stored in association with a same schema that is used for the campaign data structure 406. The schema can define, for example, a data structure format that can store a campaign identifier, one or more content groups that are associated with the campaign, one or more creatives that are associated with each content group, and selection criteria and other parameters that can be associated, for example, with a creative or with a content group. In some implementations, the schema can define fields or data items that are specific to treatment campaigns. For example, the schema can define a field which can be used to link a treatment campaign to a base campaign. For example, the draft data structure 426 can reference the campaign data structure 406. Although the draft data structure 426 is stored in the campaign database 404, the draft data structure 406 can include a setting which results in the content server 402 not selecting the treatment campaign in response to requests for content. For example, the schema can define a flag field which if set can indicate that the campaign is not to be used for servicing requests for content.

The campaign associated with the campaign data structure 406 can be referred to as an original (e.g., base) campaign. The draft data structure 426 can be referred to as a shadow data structure. In some implementations, the draft data structure 426 includes only the differences that are proposed to the original campaign and other data items that may be necessary for providing context and/or building an appropriate hierarchy of data elements. For example, the draft data structure 426 includes modified selection criteria 428 (e.g., the modified selection criteria 428 include a modified bid (e.g., $2) for the first keyword). As another example, the draft data structure 426 can include a content group 430 corresponding to the first content group 408, to provide context for the modified selection criteria 428.

The system 400 can use propagation logic using the treatment campaign to determine if any detected changes to the base campaign affect one or more variables within the existing treatment campaigns (and/or their dependent testing arms). The propagation logic can include re-running auctions using a historical data log of transactions 434 with the treatment campaign included in the auctions as a campaign that is eligible to be an auction winner. The simulation can be used to predict a success rate for implementing the changes represented by the treatment campaign. In some implementations, a simulation uses an experiment campaign and an experiment data structure rather than the treatment campaign and the draft data structure 426.

To determine a more accurate estimation of the effects of implementing the treatment campaign, an experiment can be performed. For example, when the proposed modification(s) associated with the treatment campaign (and/or its testing arms) are received from the campaign management system 418, an experiment can be automatically conducted. As another example, the content provider 420 can define and initiate an experiment using an experiment user interface 436.

For example, the content provider 420 can specify a traffic split percentage which indicates a traffic split between an experiment campaign and the original campaign. For example, during the experiment, a certain portion of traffic that would have gone to the original campaign can go to the experiment campaign. That is, the experiment campaign can participate, in place of the original campaign, in a certain percentage of auctions conducted in response to received requests for content. The original campaign can be referred to as a control arm of the experiment and the experiment campaign can be referred to as an experiment arm. The split can be percentage of traffic or can define a particular portion of traffic that is to use the experiment campaign when evaluating received requests for content (e.g., a strict amount representing X % or a portion defined by time, requesting source, environment, or other conditions).

In some embodiments, the content provider 420 can view statistics related to the experiment and/or the original campaign. The content server 402 can store campaign statistics for both the original campaign and the experiment campaign, such as in a campaign statistics database 462. For example, statistics related to impressions of content items, interactions (e.g., selections, conversions) with content items, click through rate, and cost can be stored for both the original campaign and the experiment campaign and/or testing arms. The content provider 420 can view statistics for the experiment campaign, the original campaign, and/or comparison statistics comparing the experiment campaign to the original campaign, using the experiment user interface 436.

In some embodiments, the content provider 420 can access multiple user interfaces for managing one or more treatment campaigns, such as specifying and/or modifying test variables in a simulation user interface 432, creating new experiments or modifying existing experiments through an experiment user interface 436, and/or approving/disapproving changes made by the campaign management system 418 in a treatment management user interface 424.

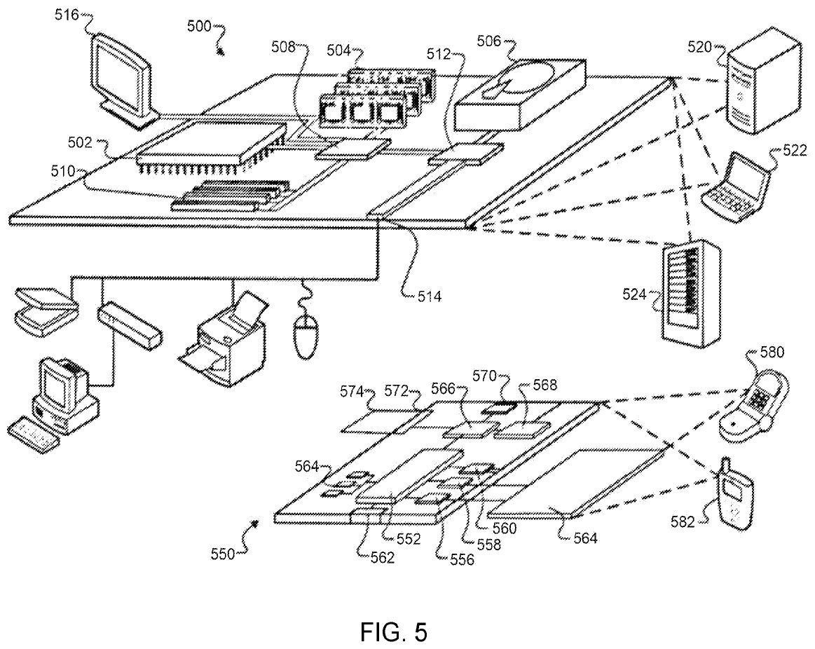

FIG. 5 illustrates a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Computing device 500 includes a processor 502, memory 504, a storage device 506, a high-speed interface 508 connecting to memory 504 and high-speed expansion ports 510, and a low-speed interface 512 connecting to low-speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high-speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. The computer-readable medium is may not be a propagating signal. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, or memory on processor 502.

The high-speed controller 508 manages bandwidth intensive operations for the computing device 500, while the low-speed controller 512 manages lower bandwidth-intensive operations. Such allocation of duties is illustrative only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication (e.g., via a docking procedure) or for wireless communication (e.g., via Bluetooth or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to device 550 through expansion interface 572, which may include, for example, a SIMM card interface. Such expansion memory 574 may provide extra storage space for device 550, or may also store applications or other information for device 550. Specifically, expansion memory 574 may include instructions to carry out or supplement the processes described above and may include secure information also. Thus, for example, expansion memory 574 may be provided as a security module for device 550 and may be programmed with instructions that permit secure use of device 550. In addition, secure applications may be provided via the SIMM cards, along with additional information, such as placing identifying information on the SIMM card in a non-hackable manner.

The memory may include for example, flash memory and/or MRAM memory, as discussed below: In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS receiver module 570 may provide additional wireless data to device 550, which may be used as appropriate by applications running on device 550.

Device 550 may also communicate audibly using audio codec 560, which may receive spoken information from a user and convert it to usable digital information. Audio codex 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a key board and a pointing device (e.g., a mouse or a trackball) by which the user can provide input to the computer. Other kinds of devices can be used to provide for interactions with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that include a front-end component (e.g., a client computer having a graphical user interface or a Web browser through which a user can interact with an implementation of the systems and techniques described here), or any combination of such backend, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the systems and methods have been described, it should be recognized that numerous other applications are contemplated. Accordingly, other embodiments are within the scope of the following claims.

1. A method comprising:
receiving, by a computing system comprising one or more processors, a subset of current campaign parameters from a third party to be a set of test variables, the set of test variables corresponding to a proposed modification of a current campaign that is applied to a treatment campaign;
monitoring, by the computing system, the current campaign for changes to the current campaign parameters;
determining, by the computing system, that a current campaign parameter has been modified by the third party;
based on the current campaign parameter being modified by the third party being outside the set of test variables, reproducing and propagating, by the computing system, the modification to the current campaign parameter to the treatment campaign; and
determining, by the computing system, an action to take based on the current campaign parameter modified by the third party causing a change to at least one of the set of test variables.

2. The method of claim 1, wherein monitoring the current campaign for changes to the current campaign parameters further comprises:
periodically polling, by the computing system, the current campaign run by the third party; comparing the current campaign parameter to a historical version of the current campaign parameter; and
determining that the current campaign parameter has been modified by the third party from the historical version of the current campaign parameter.

3. The method of claim 1, the method further comprising:
inferring that the modification by the third party to the current campaign parameter, while not part of the subset of current campaign parameters, should be tested by the treatment campaign;
dynamically creating a new test variable; and
dynamically modifying the set of test variables to include the new test variable.

4. The method of claim 1, wherein reproducing and propagating the modification to the current campaign parameter to the treatment campaign further comprises:
receiving the current campaign parameter that has been modified as input to an application programming interface;
interpreting a functionality that has been modified as a result of the modification to the current campaign parameter; and
dynamically generating the functionality in a separate command structure to be implemented in the treatment campaign.

5. The method of claim 1, the method further comprising:
determining that the modification to the current campaign parameter causes a change to at least one of the set of test variables; and
based on the determination, dynamically creating a second treatment campaign to test the set of test variables separately from the treatment campaign.

6. The method of claim 1, wherein, based on the current campaign parameter not causing a modification to at least one of the set of test variables, the modification to the current campaign parameter is published to the treatment campaign.

7. The method of claim 1, wherein the modification to the current campaign parameter is stored as an experiment variable within the set of test variables.

8. A system comprising:
one or more processors; and
one or more memory elements including instructions that when executed cause the one or more processors to:
receive, by a computing system comprising one or more processors, a subset of current campaign parameters from a third party to be a set of test variables, the set of test variables corresponding to a proposed modification of a current campaign that is applied to a treatment campaign;
monitor, by the computing system, the current campaign for changes to the current campaign parameters;
determine, by the computing system, that a current campaign parameter has been modified by the third party;
based on the current campaign parameter being modified by the third party being outside the set of test variables, reproduce and propagate, by the computing system, the modification to the current campaign parameter to the treatment campaign; and
determine, by the computing system, an action to take based on the current campaign parameter modified by the third party causing a change to at least one of the set of test variables.

9. The system of claim 8, wherein monitoring the current campaign for changes to the current campaign parameters further causes the one or more processors to:
periodically poll, by the computing system, the current campaign run by the third party; compare the current campaign parameter to a historical version of the current campaign parameter; and
determine that the current campaign parameter has been modified by the third party from the historical version of the current campaign parameter.

10. The system of claim 8, the instructions that when executed cause the one or more processors to further:
infer that the modification by the third party to the current campaign parameter, while not part of the subset of current campaign parameters, should be tested by the treatment campaign;
dynamically create a new test variable; and
dynamically modify the set of test variables to include the new test variable.

11. The system of claim 8, wherein reproducing and propagating the modification to the current campaign parameter to the treatment campaign further causes the one or more processors to:
receive the current campaign parameter that has been modified as input to an application programming interface;
interpret a functionality that has been modified as a result of the modification to the current campaign parameter; and
dynamically generate the functionality in a separate command structure to be implemented in the treatment campaign.

12. The system of claim 8, the instructions that when executed cause the one or more processors to further:
determine that the modification to the current campaign parameter causes a change to at least one of the set of test variables; and
based on the determination, dynamically create a second treatment campaign to test the set of test variables separately from the treatment campaign.

13. The system of claim 8, wherein, based on the current campaign parameter not causing a modification to at least one of the set of test variables, the modification to the current campaign parameter is published to the treatment campaign.

14. The system of claim 8, wherein the modification to the current campaign parameter is stored as an experiment variable within the set of test variables.

15. A computer readable medium embodied in a computer-readable storage device and comprising instructions that, when executed by a processor, cause the processor to:
receive, by a computing system comprising one or more processors, a subset of current campaign parameters from a third party to be a set of test variables, the set of test variables corresponding to a proposed modification of a current campaign that is applied to a treatment campaign;
monitor, by the computing system, the current campaign for changes to the current campaign parameters;
determine, by the computing system, that a current campaign parameter has been modified by the third party;
based on the current campaign parameter being modified by the third party being outside the set of test variables, reproduce and propagate, by the computing system, the modification to the current campaign parameter to the treatment campaign; and
determine, by the computing system, an action to take based on the current campaign parameter modified by the third party causing a change to at least one of the set of test variables.

16. The computer readable medium of claim 15, wherein monitoring the current campaign for changes to the current campaign parameters further cause the processor to:
periodically poll, by the computing system, the current campaign run by the third party; compare the current campaign parameter to a historical version of the current campaign parameter; and
determine that the current campaign parameter has been modified by the third party from the historical version of the current campaign parameter.

17. The computer readable medium of claim 15, the instructions that, when executed by the processor, cause the processor to:
infer that the modification by the third party to the current campaign parameter, while not part of the subset of current campaign parameters, should be tested by the treatment campaign;
dynamically create a new test variable; and
dynamically modify the set of test variables to include the new test variable.

18. The computer readable medium of claim 15, wherein reproducing and propagating the modification to the current campaign parameter to the treatment campaign further cause the processor to:
receive the current campaign parameter that has been modified as input to an application programming interface;
interpret a functionality that has been modified as a result of the modification to the current campaign parameter; and
dynamically generate the functionality in a separate command structure to be implemented in the treatment campaign.

19. The computer readable medium of claim 15, the instructions that, when executed by the processor, cause the processor to:
determine that the modification to the current campaign parameter causes a change to at least one of the set of test variables; and
based on the determination, dynamically create a second treatment campaign to test the set of test variables separately from the treatment campaign.

20. The computer readable medium of claim 15, wherein, based on the current campaign parameter not causing a modification to at least one of the set of test variables, the modification to the current campaign parameter is published to the treatment campaign.

21. (canceled)
